(19) United States
(12) Patent Application Publication
(10) Pub. No.: US 2015/0004024 A1
(43) Pub. Date: Jan. 1, 2015

(54) CLAMPING RING WITH FORCE LIMITATION

(71) Applicant: GRUNDFOS HOLDING A/S, Bjerringbro (DK)

(72) Inventor: Knud Jørgen Saaby Mikkelsen, Ans by (DK)

(21) Appl. No.: 14/377,328

(22) PCT Filed: Jan. 17, 2013
(86) PCT No.: PCT/EP2013/050862

§ 371 Date: Aug. 7, 2014

(30) Foreign Application Priority Data
Feb. 8, 2012 (EP) 12154491.0

(51) Int. Cl. F04D 17/10; F16L 23/10; F04D 29/62

(52) U.S. Cl. CPC F04D 17/10; F04D 29/62; F16L 23/10
USPC 417/410.1; 29/888.024; 285/367

(57) ABSTRACT

A clamping ring (11) for the connection of two flanges includes an open ring section (17) which is designed for receiving the flanges (9, 10) to be connected. The flanges (9, 10) have ends connected by way of a clamping device (21-27) which is attached on the ring section (17). With the clamping device (21-27), the ends of the ring section (17) can be moved onto one another and thus the clamping ring (11) can be clamped amid the integration of the flanges (9, 10). The clamping device (21-27) includes a clamping force limitation device (27), in order to prevent an unintended failure of the clamping device (21-27) on assembly.

### CROSS REFERENCE TO RELATED APPLICATIONS

This application is a United States National Phase Application of International Application PCT/EP2013/050862 filed Jan. 17, 2013 and claims the benefit of priority under 35 U.S.C. §119 of European Patent Application EP 12154491.0 filed Feb. 8, 2012, the entire contents of which are incorporated herein by reference.

### FIELD OF THE INVENTION

The invention relates to a clamping ring for the connection of two flanges, in particular for connection of a flange on the motor housing side to a flange of an electromotorically driven circulation pump, which is on the pump housing side.

### BACKGROUND OF THE INVENTION

Clamping rings for flange connections are counted as belonging to the state of the art. They typically comprise an open ring section which is designed for receiving the flanges to be connected and whose ends are connected by way of a clamping device which is attached on the ring section and with which the ends of the ring sections are moved to one another and can be clamped amid the integration of the flanges.

ISO small flange systems according to DIN 28 403 and ISO 2861 are counted as belonging to the state of the art. Such clamping rings serve for the connection of conduit flanges amid the integration of a seal, and they consist for example of two open ring sections which extend roughly by about 180° and which on one side are connected to a joint and on the other side to a clamping device in the form of a clamping screw with a nut. The ring sections are regularly over-dimensioned, so that the clamping device often represents the weakest link. This is basically not a problem if the clamping ring is assembled by the trained person, in the correct manner. However, one may not rule out such a clamping ring also be attached by a less skilled amateur. Then, with an incorrect handling, in particular with the use of a tool with a long lever arm, it can occur that the clamping screw is tightened beyond the correct torque, which can lead to a tearing-away of the screw and thus to a spontaneous opening of the clamping ring connection. This is particularly dangerous with conduits, in which aggressive fluids or heated fluids or gasses are transported. If for example, with a heating circulation pump, the motor and the pump are connected via such a flange connection by way of a clamping ring, then the sudden failure of the connection can lead to heavy components detaching in an uncontrolled manner and falling to the ground and/or to hot fluid exiting at the end of the pump which is then free.

### SUMMARY OF THE INVENTION

Against this background, it is an object of the invention to design a clamping ring such that it can be assembled by the amateur without any danger, and without the danger of a sudden unexpected opening of the clamping ring.

The clamping ring according to the invention for the connection of two flanges comprises at least one open ring section which is designed for receiving the flanges to be connected and whose ends are connected by way of a clamping device which is attached on the ring section and with which the ends of the ring section can be moved to one another and can be clamped amid the integration of the flanges. According to the invention, the clamping device comprises a clamping force limitation means. An overloading of the clamping device, and thus a sudden breakage of this when clamping, can be reliably prevented by way of the clamping force limitation means according to the invention. The clamping force limitation means is thereby usefully dimensioned such that an overload of the clamping device is reliably ruled out when clamping.

The basic concept of the present invention is to design the clamping ring such that this cannot be tightened with an unallowably high force, in order thus to prevent the clamping ring or the clamping device from being damaged when attaching this.

Advantageously, at least one ring section of the claiming ring has an inwardly open channel-profile profile, so that the ring section with its channel profile can engage around the two flanges to be connected, on the peripheral side as well as on the end-sides in the end region which are away from one another in each case. Such a design ensures that with a clamped clamping ring, apart from the non-positive connection, a positive connection also exists, which connects the flanges to one another with a positive fit, independently of the clamping force.

Basically, with regard to design, a screw-nut connection as part of the clamping device has proven its worth, wherein positive-fit means for applying a tool are provided either on the screw side or on the nut side. According to one advantageous development of the invention, the positive-fit means forms the clamping force limitation means of the clamping ring. Such a design is particularly advantageous, since only one component is to be designed in a particular manner, in order to achieve a clamping force limitation of the clamping ring.

Advantageously, the clamping device comprises a clamping screw, at whose end a tool receiver is arranged, which is dimensioned such that the force transmitted by the tool onto the screw is dimensioned for the intended limitation of the clamping force. The same effect can also be achieved in a kinematic reversal by way of a suitable design of the nut. The design on the clamping screw however is particularly advantageous, since it is only the screw which is to be dimensioned accordingly, in particular the screw head, on which the tool is to be applied.

Thereby, it is particularly advantageous if the clamping screw comprises a screw head with an inner profile for receiving the tool, since then a clamping force limitation is most simple to realize, by way of the inner profile of the screw head or the screw head itself having a size as is usually provided for a screw of a smaller thread diameter than that of the clamping screw. Such screws with an inner profile are nowadays commonly used, since they can be assembled in a particularly secure manner with a tool, and there is little danger of slippage. Moreover, the tool is received within the screw head largely with a positive fit. Such profilings can for example be a hexagonal socket, Torx, Schlitz, Philips, POSIDRIVE, Robertson, Tri-Wing or likewise. Thereby, it has been surprisingly found that with the use of a screw head of a size as is usually envisaged for a screw of a smaller thread diameter, the desired effect of the clamping force limitation is given already in an optimal manner. Thus, for example, advantageously a clamping screw with an M7 thread and a screw head with a hexagon socket profile can be applied, as this screw head is usually provided on a screw with an M6 thread. Such an arrangement moreover has the advantage that the screw head can be tightened without a special tool. With a suitable material selection, for example if the screw consists completely of stainless steel, then with the previously mentioned combination, there results the effect that on tightening the screw beyond a correct torque, this does not rotate further, but the tool rotates in the receiver in the screw head, thus the inner profile in the screw head is damaged or destroyed.

The latter as a rule can be accepted without further ado, since a targeted removal of the screw by the man skilled in the art is possible even with a damaged screw head, but with such a design which is requires little effort with regard to design, one can reliably prevent an overstraining of the clamping screw and thus a possible spontaneous danger of breakage.

In order to produce a movement of the flanges to one another upon tightening the clamping device, it is advantageous if the open ring section comprises a peripheral wall and side walls connecting laterally thereto, which diverge from the peripheral wall towards the longitudinal middle axis of the ring. A pressing of the flanges onto one another when tightening the clamping device is achieved in this manner. This effect can alternatively also be achieved by was of the flanges themselves being designed in a bevelled manner and the sides running transversely to the longitudinal middle axis of the ring.

The clamping ring according to the invention in particular can advantageously be applied for connecting the pump housing and the motor housing of a centrifugal pump assembly.

Such a centrifugal pump assembly comprises an electric motor which is arranged in a motor housing, and an impeller which is arranged in pump housing and is driven by the motor. The motor housing has a flange on the motor housing side and the pump housing has a flange on the pump housing side, which are fastened to one another by way of the clamping ring. Such a fastening is particularly advantageous since it can typically be released or created with only one screw. If then this screw is designed as previously described, then this results in an increased safety with regard to the wrong operation on tightening the clamping ring.

Advantageously, this flange connection is designed with a one-sided centering projection which engages into a corresponding centering bore formed on the other side, in order to ensure that no alignment errors occur. Particularly advantageously, the centering projection is provided on the motor housing, specifically on the flange on the motor housing side, and the centering bore is provided within the flange on the pump housing side. Basically, the arrangement can however also be the other way round.

In order hereby, to also ensure the sealedness of the housing connections, a seal is advantageously integrated, preferably an O-ring, which on the end-side bears on the centering projection on the motor housing side and within the centering bore on the pump housing side. Advantageously, a bearing plate for receiving a shaft bearing can yet be integrated between this connection.

The invention is hereinafter explained in more detail by way of one embodiment example which is represented in the drawing. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a greatly simplified schematic sectional representation showing a pump assembly with a clamping ring flange connection;

FIG. 2 is a a lateral view showing the pump assembly;

FIG. 3 is a perspective view showing a clamping ring with a clamping device; and

FIG. 4 is an exploded representation showing the clamping ring according to FIG. 3.

### DESCRIPTION OF THE PREFERRED EMBODIMENTS

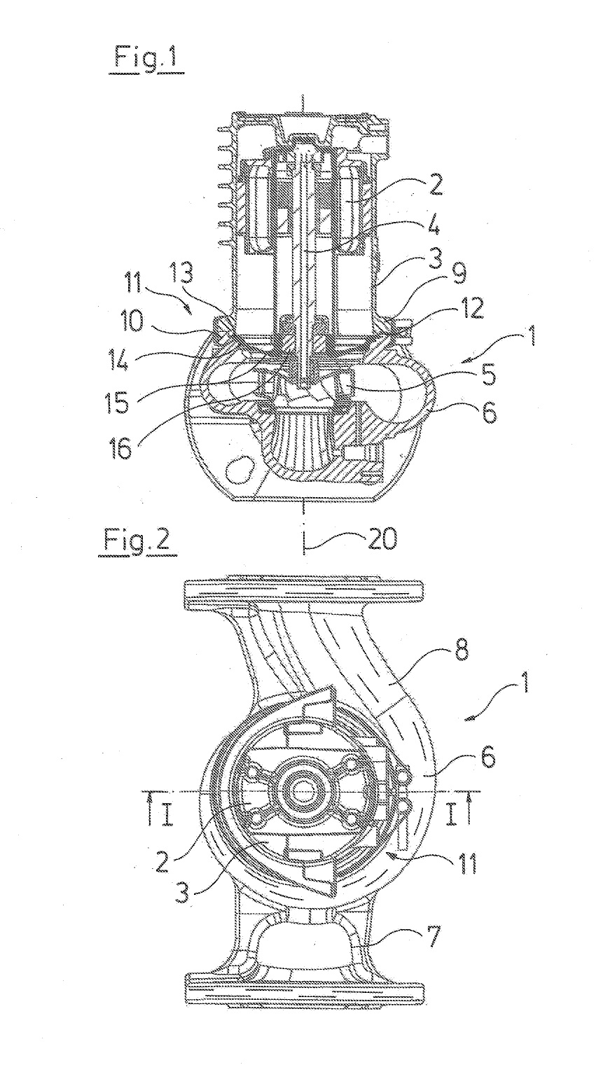

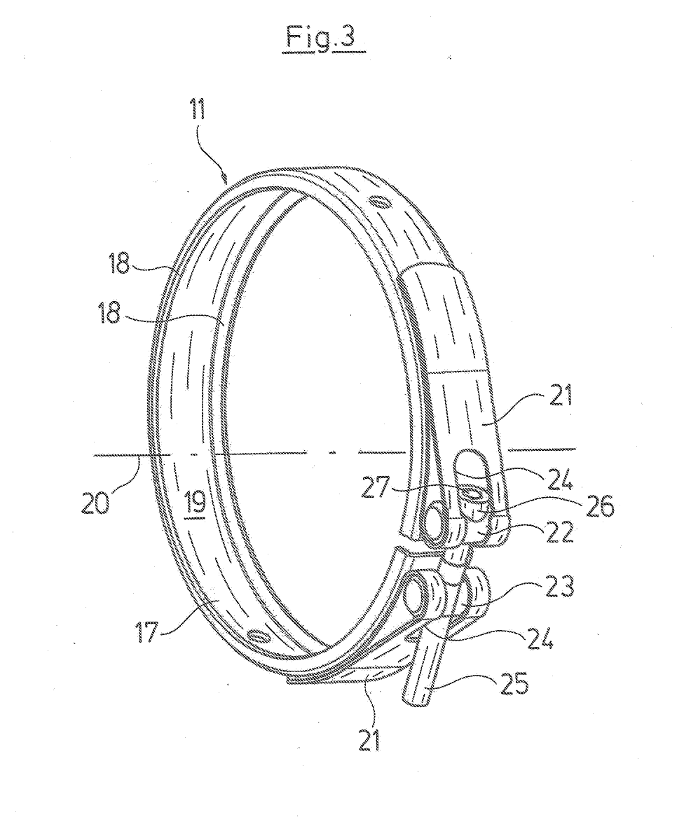

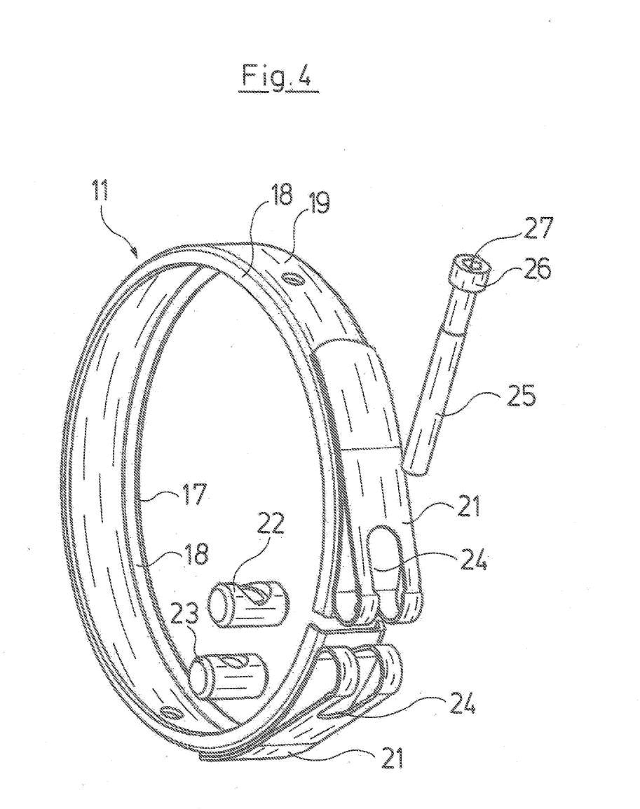

Referring to the drawings in particular, the centrifugal pump assembly represented in FIGS. 1 and 2 is comprised of a centrifugal pump 1 and of an electric motor 2 driving this. The electric motor 2 is received within a motor housing 3 and with a shaft 4 drives an impeller 5 of the pump 1 which is rotatably mounted within a pump housing 6. The pump housing comprises a suction connection 7, through which fluid enters into the pump housing, and a pressure connection 8, through which this exits out of the pump.

The motor housing 3 comprises a flange 9 which is arranged concentrically to the shaft 4, and the pump housing 6 comprises a flange 10 which is likewise arranged concentrically to the shaft 4, and these flanges can be connected by way of a clamping ring 11 for the connection of both housings.

A centering bore 12 is provided within flange 10 on the pump housing side, which is to say belonging to the pump housing, into which centering bore an annular centering projection 13 projecting on the outer side of the flange 9 engages. The centering projection 13 is received in the centering bore 12 amid the integration of an O-ring 14 as well as a bearing plate 15 which receives a centeral bearing 16 for the shaft 4. The O-ring 14 lies between the face-end of the centering bore 12 and the bearing plate 15 or the centering projection 13 arranged therebehind.

The clamping ring 11 consists of an open ring section which extends about 350° around the flanges 9 and 10 and which has an inwardly open channel profile, thus open to the flanges 9 and 10. The ring section 17 engages around the flanges 9 and 10 on the peripheral side and partly with the lateral walls 18 which diverge from the peripheral wall 19 to the longitudinal middle axis 20 of the ring 11, in order to press the flanges 9 and 10 onto one another upon tightening the clamping ring 11.

Sheet-metal sections 21 are welded on the outer side close to the ends of the ring section 17 and extend in each case to one end of the ring section 17, are deflected on this by 180° amid the integration of a bolt 22 and 23, and are led back again. A cylinder bolt 22 with a stepped bore running transversely therein is provided in the region of the deflection location, and a cylinder bolt 23 with a threaded bore running transversely therein is provided on the other sheet-metal section 21. The sheet-metal sections are applied around the cylinder bolts 22 and 23 and in the middle region comprise recesses 24 which render the stepped bore or the threaded bore accessible to a clamping screw 25 or to a tool which reaches this. The clamping screw 25 with its screw head 26 is seated in the stepped bore of the cylinder bolt 22, and bridges the open section of the ring section 17, in order to then engage into the thread of the cylinder bolt 23 at the other end. The cylinder bolts 22, 23 in combination with the clamping screw 25 represent a clamping device, with which the open ring section 17 can be tightened amid the integration of the flanges 9 and 10. Depending on how far the clamping screw 25 is rotated into the threaded bore of the cylinder bolt 23, the flanges 9 and 10 are pressed onto one another by way of the side walls 18 with their diverging shape pressing these onto one another.

In order to prevent the clamping screw 25 from being tightened too much and thus being overstressed, by which means there would be a danger of breakage of the screw and thus a sudden opening of the clamping ring 11, the clamping device comprises a clamping force limitation means which, with this screw, is formed by the screw head 26. The screw head 26 comprises a hexagon socket profile 27 which is envisaged for receiving a corresponding hexagonal socket tool, in particular Allen key. The hexagon socket profile 27 of the screw head 26 is designed in a suitably small manner, in order to prevent the clamping screw 25 being tightened with an unallowably high torque with the help of the tool. In the present embodiment example, the clamping screw 25 has an M7 thread, but the screw head 26 however corresponds to that which usually belongs to an M6 screw. With the shown clamping ring, the clamping screw 25 is designed from stainless steel and the cylinder bolts 22 and 23 of steel, so that the clamping screw 25 represents the weakest part of the connection. Due to the design of the hexagon socket profile 27 which is smaller compared to normal clamping screws, this screw 25 can only be tightened with a comparatively small torque. If the tightening force is increased further, the hexagon socket profile 27 is damaged or destroyed, but the clamping screw 25 is not rotated further. An overload safeguard is formed in this manner.

The cylinder bolt 23 as well as the cylinder bolt 22 is formed from galvanised steel in order to ensure that in particular on release of the connection, the clamping screws 25 does not eat into the cylinder bolt 23, as this can often be observed with stainless steel/stainless steel connections.

While specific embodiments of the invention have been shown and described in detail to illustrate the application of the principles of the invention, it will be understood that the invention may be embodied otherwise without departing from such principles.

1. A clamping ring for the connection of two flanges, the clamping ring comprising:
at least one open ring section for receiving the flanges to be connected:
a clamping device for connecting ends of the open ring section, the clamping device being attached on the ring section, wherein the ends of the open ring section are moved to one another and can be clamped amid the integration of the flanges, wherein the clamping device comprises a clamping force limitation means for limiting a clamping force applied by the clamping device.

2. A clamping ring according to claim 1, with which the ring section has an inwardly open channel profile.

3. A clamping ring according to claim 1, wherein the clamping device comprises a screw-nut arrangement with a positive-fit means for applying a tool, wherein the positive-fit means forms the clamping force limitation means.

4. A clamping ring according to claim 1, wherein the clamping device comprises a clamping screw having an end with a tool receiver is arranged thereat, said tool receiver being dimensioned such that a force which can be transmitted from the tool onto the screw is dimensioned for the correct limitation of the clamping force.

5. A clamping ring according to claim 4, wherein the clamping screw comprises a screw head with an inner profile for receiving the tool, wherein the inner profile of the screw head and/or the screw head has a size for a screw of a smaller thread diameter than that of the clamping screw.

6. A clamping ring according to claim 1, wherein the open ring section comprises a peripheral wall and side walls which connect laterally thereto and which diverge from the peripheral wall to the longitudinal middle axis of the ring.

7. A a clamping ring according to claim 1, in combination with a pump housing and a motor housing wherein the clamping ring connects the pump housing and the motor housing of a centrifugal pump assembly.

8. A centrifugal pump assembly comprising:
a motor housing receiving an electric motor;
a pump housing receiving an impeller, the motor housing having a flange on a motor housing side and the pump housing having a flange on a pump housing side;
a clamping ring comprising:
at least one open ring section for receiving the flanges;
a clamping device for connecting end of the open ring section, the clamping device being attached on the ring section, wherein the ends of the open ring section are moved toward one another and are clamped in position for holding the flanges, wherein the clamping device comprises a clamping force limitation means for limiting a clamping force applied by the clamping device, said flanges being fastened to one another by way of a clamping ring claim 1.

9. A centrifugal pump assembly according to claim 8, wherein the flange on the motor housing side comprises a centering projection (13) which projects to the pump housing and which engages into a centering bore which is formed within the flange on the pump housing side in a corresponding manner.

10. A centrifugal pump assembly according to claim 8, further comprising an O-ring, wherein the pump housing and the motor housing are sealingly connected to one another amid the integration of the O-ring which on the end-side bears indirectly or directly on the centering projection on the motor housing side and within the centering bore on the pump housing side.

11. A centrifugal pump assembly according to claim 9, further comprising an O-ring, wherein the pump housing and the motor housing are sealingly connected to one another amid the integration of the O-ring which on the end-side bears indirectly or directly on the centering projection on the motor housing side and within the centering bore on the pump housing side.

12. A centrifugal pump assembly according to claim 9, wherein the open ring section has an inwardly open channel profile comprising a peripheral wall and side walls which connect laterally thereto and which diverge from the peripheral wall to the longitudinal middle axis of the ring.

13. A centrifugal pump assembly according to claim 9, wherein the clamping device comprises a screw-nut arrangement with a positive-fit means for applying a tool, wherein the positive-fit means forms the clamping force limitation means and a clamping screw having an end with a tool receiver arranged thereat, said tool receiver being dimensioned such that a force which can be transmitted from the tool onto the screw is dimensioned for the correct limitation of the clamping force.

14. A centrifugal pump assembly according to claim 13, wherein the clamping screw comprises a screw head with an inner profile for receiving the tool, wherein the inner profile of the screw head and/or the screw head has a size for a screw of a smaller thread diameter than that of the clamping screw.

15. A method of forming a centrifugal pump assembly, the method comprising the steps of:
providing a motor housing with an electric motor received therein, the motor housing having a motor housing flange on a motor housing side;
providing a pump housing with an impeller received therein, the pump housing having a pump housing flange on a pump housing side
providing a clamping ring comprising:
at least one open ring section for receiving the flanges;
a clamping device for connecting end of the open ring section, the clamping device being attached on the ring section;
moving the ends of the open ring section toward one another and clamping the ends in position for holding the flanges, wherein the clamping device comprises a clamping force limitation means for limiting a clamping force applied by the clamping device, said flanges being fastened to one another by way of a clamping ring.

16. A method according to claim 15, wherein the flange on the motor housing side comprises a centering projection which projects to the pump housing and which engages into a centering bore which is formed within the flange on the pump housing side in a corresponding manner.

17. A method according to claim 15, further comprising providing an O-ring, wherein the pump housing and the motor housing are sealingly connected to one another amid the integration of the O-ring which on the end-side bears indirectly or directly on the centering projection on the motor housing side and within the centering bore on the pump housing side.

18. A method according to claim 16, further comprising providing an O-ring, wherein the pump housing and the motor housing are sealingly connected to one another amid the integration of the O-ring which on the end-side bears indirectly or directly on the centering projection on the motor housing side and within the centering bore on the pump housing side.

19. A method according to claim 16, wherein the open ring section has an inwardly open channel profile comprising a peripheral wall and side walls which connect laterally thereto and which diverge from the peripheral wall to the longitudinal middle axis of the ring.

20. A method according to claim 16, wherein the clamping device comprises a screw-nut arrangement with a positive-fit means for applying a tool, wherein the positive-fit means forms the clamping force limitation means and a clamping screw having an end with a tool receiver arranged thereat, said tool receiver being dimensioned such that a force which can be transmitted from the tool onto the screw is dimensioned for the correct limitation of the clamping force.
